(19) United States
(12) Patent Application Publication
(10) Pub. No.: US 2011/0108553 A1
(43) Pub. Date: May 12, 2011

(54) CONTAINER/LID ASSEMBLY

(76) Inventor: Joseph A. PANTELLERIA, Overland Park, KS (US)

(21) Appl. No.: 12/616,558

(22) Filed: Nov. 11, 2009

(51) Int. Cl. B65D 43/16; B23P 19/02

(52) U.S. Cl. 220/319; 220/810; 29/525

(57) ABSTRACT

A container/lid assembly that includes a container having a sidewall with at least one aperture extending through the sidewall and a lid having a ring portion with at least one projection extending therefrom that is configured to engage the aperture in the container sidewall for securing said lid to said container. The aperture extending from the lid ring portion can be configured to allow the lid ring portion to be inserted into the container sidewall but yet restrict the lid ring portion from being readily removed from the container sidewall.

### CROSS-REFERENCE TO RELATED APPLICATIONS

None.

### BACKGROUND OF THE INVENTION

Food containers having attached hinged lids are well known in the industry. Such containers will typically comprise a container body having a sidewall, a bottom wall and an upwardly opening top defined by a peripheral lip. The hinged lid is attached to the container body at the open end using some method. However, the currently known methods for attachment can be overly complex, require elaborate machinery to carryout, involve the use of potentially harmful adhesives and significantly increase the overall production cost of the container.

Accordingly, a need exists for a method of attaching a hinged lid to a container body that does not require any adhesive, does not require complex machinery and can be done using a combination of already known, standard processes. A further need exists for a method of attaching a hinged lid to a container body that is simple and cost effective to carryout.

### SUMMARY OF THE INVENTION

One embodiment of the present invention is directed to a container/lid assembly that includes a container having a sidewall with at least one aperture extending therethrough and a lid having a ring portion with at least one projection extending therefrom that is configured to engage the aperture in the container sidewall for securing the lid to the container.

Another embodiment of the present invention is directed to a container/lid assembly that includes a container and a lid. The container has a continuous sidewall, an open end and a closed end. The container also includes at least one aperture extending through the sidewall proximate its open end. The lid has a ring portion and a cover portion that are hingedly attached to one another and are capable of being integrally molded as a single component. The ring portion is configured to be received by the container open end and has at least one extent that is configured to engage the aperture in the sidewall for interlocking the lid to the container.

A further embodiment of the present invention is directed to a lid for a container that includes a ring portion and a cover portion. The ring portion has at least one extent extending therefrom and is configured to be received by a container sidewall. The extent extending from the ring portion is configured to engage an aperture in the container sidewall. The cover portion and ring portion are hingedly coupled and integrally molded as a single component.

The present invention is also directed to a method of attaching a lid to a container including the steps of providing a container having a continuous sidewall with at least one aperture extending therethrough and an opening, providing a lid having a ring portion with at least one projection extending therefrom configured to engage the aperture in the container sidewall for securing the lid to the container, aligning the lid ring portion with the container opening, inserting the lid ring portion into the container opening, and causing the projection to engage the aperture such that the lid is secured to the container.

Certain embodiments of the invention are outlined above in order that the detailed description thereof may be better understood, and in order that the present contributions to the art may be better appreciated. In this respect, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention. Though some features of the invention may be claimed in dependency, each feature has merit when used independently.

### DESCRIPTION OF THE SEVERAL VIEWS OF THE DRAWINGS

Further features of the present invention will become apparent to those skilled in the art to which the present invention relates from reading the following description with reference to the accompanying drawings, in which:

FIG. 1 is an exploded front perspective view of a container/lid assembly in accordance with one embodiment of the present invention;

FIG. 2 is an assembled front perspective view of a container/lid assembly in accordance with one embodiment of the present invention;

FIG. 3 is a sectional front perspective view of a lid with a protruding extent portion in accordance with one embodiment of the present invention;

FIG. 4 is an assembled sectional front perspective view of a container/lid assembly in accordance with one embodiment of the present invention; and

FIG. 5 is a sectional front perspective view of extent protruding from a lid engaging an aperture of a container sidewall in accordance with one embodiment of the present invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

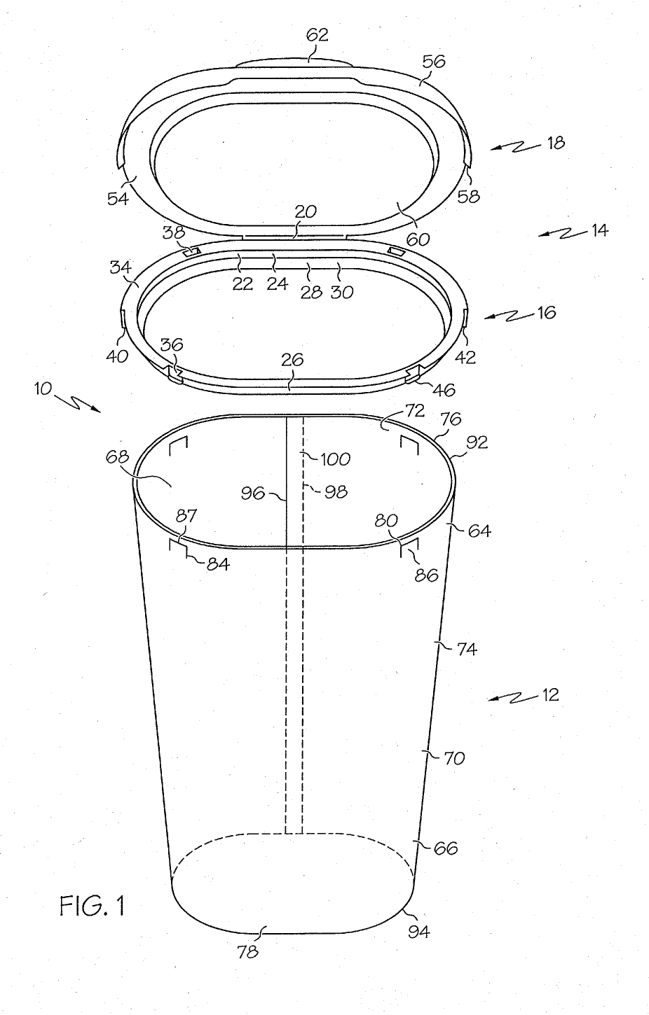

One embodiment of the present invention is directed to a container/lid assembly 10 that includes a container body 12 and a lid 14. As shown in FIG. 1, the container body 12 is constructed of a sidewall 70 and a bottom wall 78. The container body 12 has a first end 64 and a second end 66. The first end 64 can have an opening 68 defined by an unfinished sidewall upper lip 76. As discussed in further detail below, the sidewall 70 has apertures 102 proximate its first end 64 suitable for use in attaching a lid 14.

The sidewall 70 can be formed out of a single blank or flat sheet of material. The blank or sheet of material is generally in the form of a square, rectangle or arc. The blank or sheet has a top edge 92, a bottom edge 94, and side edges 96, 98. The blank or sheet can be cut from a larger sheet of material using a standard, commonly-known die cutting process or any other cutting process now known or hereafter developed. As mentioned above, the sidewall 70 has apertures 102. The apertures 102 may be formed in the sidewall 70 using the same cutting process used to cut the blank or sheet and may be formed at the same time the blank or sheet is being cut.

Once the sidewall 70 blank or sheet is cut, it is wrapped about a longitudinal axis such that its top edge 92 forms an unfinished upper lip 76 and its bottom edge 94 is secured to a bottom wall 78 using any means now known or hereafter developed, including adhesives and heat sealing means. The sidewall 70 and bottom wall 78 together form a storage cavity for receiving and storing dry, semi-dry and/or liquid products.

When the blank or sheet of material is wrapped about a longitudinal axis, its side edges 96, 98 are brought together and secured in an overlapping relation to form a side seam 100, again using any means now known or hereafter developed, including adhesives and heat sealing means. When the container body 12 is assembled, the sidewall 70 extends vertically upward from the outer periphery of the bottom wall 78 and terminates in an unfinished upper lip 76. The sidewall 70 has an inner surface 72 and an outer surface 74.

In the present invention, the sidewall's upper lip 76 can remain in an unfinished state. The upper lip 76 does not have to be rolled, formed, crimped, threaded or molded, thereby simplifying the container body's 12 construction process and reducing its production cost.

As shown in FIG. 1, the bottom wall 78 is formed of a flat generally oval or oblong sheet of material. However, it will be appreciated by one skilled in the art that the bottom wall 78 can be formed in other shapes as well. In one embodiment, the shape of the bottom wall 78 is substantially similar to that of the lid 14.

The sidewall 70 and bottom wall 78 can be constructed from plastic materials, such as polypropylene or polyethylene, or can be constructed from paperboard or molded pulp materials or any other materials having similar mechanical properties, such as being lightweight and pliable.

The container body 12 may also take a variety of shapes, in part depending upon the shape of the bottom wall 78. Additionally, the sidewall 70 of the container body 12 may have a frustoconical configuration or straight walled configuration. The sidewall 70 may be formed of a light gauge flexible plastic. When the sidewall 70 is formed of a light gauge plastic, the shape of the periphery of the upper sidewall lip 76 may not be identical to the cross-sectional shape of the bottom wall 78 prior to mating with the lid 14. Rather, because the sidewall 70 was formed from a flat sheet of material, it has a tendency to spring back to that flat shape, thereby causing the upper sidewall lip 76 to take on a cross-sectional shape slightly different from that of the shape of the bottom wall 78.

As mentioned above, there are apertures 102 extending through the sidewall 70 proximate its first end 64. These apertures 102 are used in attaching the lid 14. The apertures 102 can be formed from cuts 80. The cuts 80, which may be created at the same time the overall sidewall 70 die cut is made, can have a generally inverted u-shaped configuration. The cuts 80 can consist of a top or horizontal portion 82 and two side or vertical portions 84 forming a flap 86. However, it will be appreciated by one skilled in the art that the cuts 80 need not take on this exact configuration. Instead, the cuts 80 can be formed in any configuration that enables them to form an aperture 102 that can be engaged by an extent 46 protruding from the lid 14, as will be discussed in greater detail below. As shown in FIG. 1, the sidewall 70 contains four circumferentially-spaced cuts 80. However, it is understood that the sidewall 70 may contain any quantity of cuts 80 suitable for attaching the lid 14.

In the present invention, the sidewall 70 is not formed through an injection molding process like the sidewalls of many currently available containers. Rather, as described above, the sidewall 70 is die cut from a flat sheet of material. This permits for a thinner sidewall than what would commonly be allowed with injection molded containers. With injection molded containers, in order to positively attach a lid to the sidewall, holes or undercuts have to be formed in the sidewall, which would require a thicker sidewall construction. With the die cut approach of the present invention, the sidewall 70 can remain relatively thin, while still providing a means for positively securing the lid 14 to the sidewall 70.

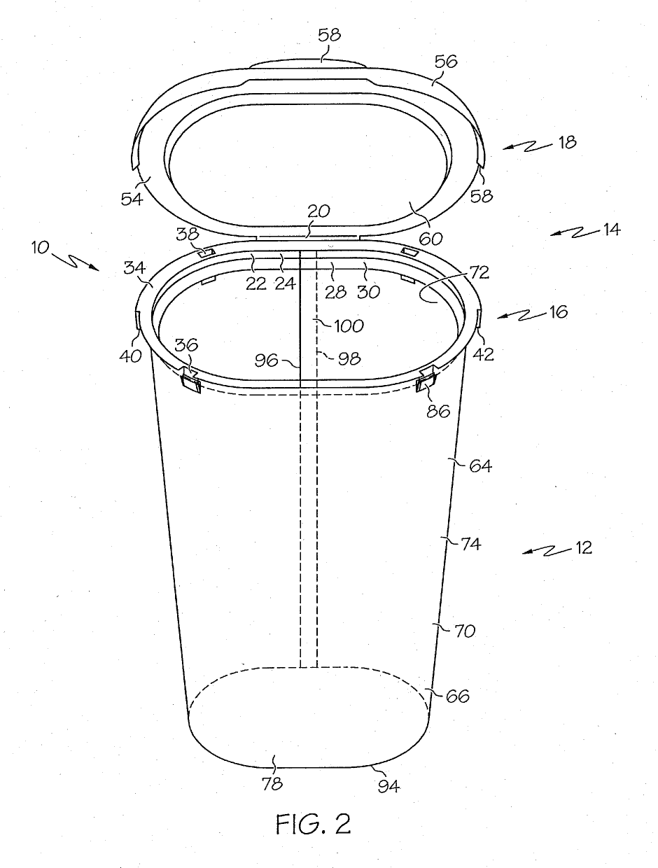

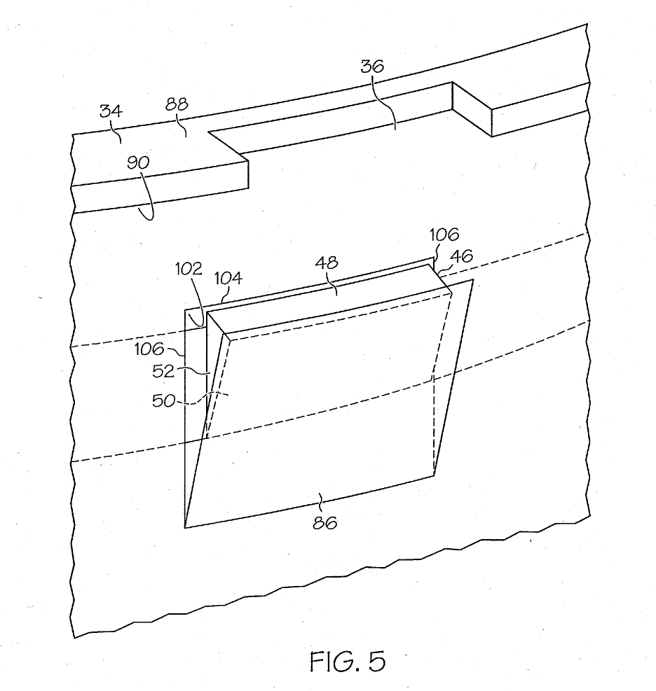

As mentioned above, the apertures 102 are formed from die cuts 80 that can be created at the same time the overall sidewall 70 is cut from a sheet of material. As demonstrated in FIGS. 2, 4 and 5, the flaps 86 formed by the cuts 80 remain attached to the sidewall 70. This is an advantage in that the process does not require the removal of scrap pieces, as would be necessary if a full-circumference cut or hole was made. This eliminates loose scrap amongst the stacks of formed sidewalls 70 and eliminates the possibility of scrap being stuck to or carried inside of the container bodies 12 as they are shipped to customers. Aesthetically, the remaining flap area covers the extents 46 that protrude from the lid's ring portion 16.

The container/lid assembly 10 of the present invention also contains a lid 14. As shown in FIG. 1, the lid 14 includes a ring portion 16 and a cover portion 18. The ring portion 16 and cover portion 18 can be hingedly coupled. However, it will be appreciated by one skilled in the art that the lid 14 need not be a hinge-type lid and that the ring portion 16 and cover portion 18 need not be hingedly attached.

As illustrated in FIG. 1, the ring portion 16 and cover portion 18 are coupled through a living hinge 20. In such an embodiment, the ring portion 16, cover portion 18 and living hinge 20 can be integrally molded as a single component. The living hinge 20 is thin and flexible. The ring portion 16, cover portion 18 and living hinge 20 can be formed through any commonly known molding process, such as injection molding, vacuum forming, and thermoforming.

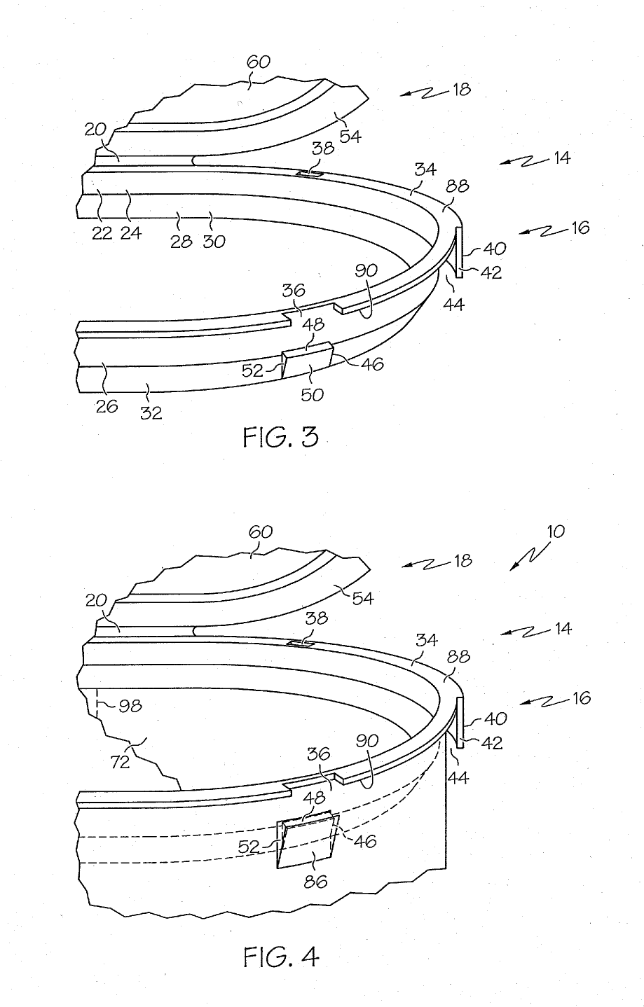

As illustrated in FIG. 3, the ring portion 16 consists of an upper section 22, having an inner surface 24 and an out surface 26, and a lower section 28, having an inner surface 30 and an out surface 32. For reasons discussed below, the lower section 28 can extend radially inward towards the center of the ring portion 16.

The ring portion 16 also includes an annular rim 34 that extends radially outward from and is substantially perpendicular to the upper section 22. The rim 34 has a top surface 88 and a bottom surface 90. As shown in FIG. 3, the ring portion 14 also consists of a skirt 40 extending downwardly from the rim 34 in a manner substantially parallel to the upper section 22. The upper section 22, rim 34 and skirt 40 thereby create an annular groove 44. The skirt 40 need not be continuous around the entire rim 34 and may terminate at ends 42.

As best illustrated in FIG. 3, the ring portion 16 contains extents 46 for securing the lid 14 to the container body 12. The extents 46 are projections that extend from the ring portion 16. The extents 46 are configured to engage the apertures 102 in order to secure the lid 14 to the container body 12. The inclination of the extent bottom surface 50 allows the upper and lower sections 22, 28 of the ring portion 14 to be inserted into the container opening 68. The extent top surface 48 restricts the ring portion 14 from being readily removed from the container opening 68 by coming into to contact with the aperture's 102 top edge 104. Therefore, the extents 46 allow the lid ring portion 14 to be received by the container opening 68, but restrict the lid ring portion 68 from being readily removed from the container opening 68 after the extents 46 engage the apertures 102.

The ring portion 14 is also restricted from rotating within the container opening 68 due to the extent side surfaces 52 coming into contact with the aperture side edges 106. Additionally, the ring portion 14 is restricted from dropping further into the container body 12 because the rim bottom surface 90 is seated on the sidewall upper lip 76.

As shown in FIG. 1, the ring portion 16 contains four circumferentially-spaced extents 46. However, it is understood that the ring portion 16 may contain any quantity of extents 46 suitable for attaching the lid 14 to the container body 12. The number of extents 46 on the ring portion 16 normally corresponds to the number of apertures 102 in the sidewall 70.

In one embodiment, as shown in FIG. 4, the ring portion 16 is configured to be received by the container body 12, such that the ring portion 16 is inserted into the sidewall 70 proximate one of the sidewall ends 64. In such an embodiment, the extents 46 extend outwardly from the outer surfaces 26, 32 of the ring portion 16.

In another embodiment (not shown), the ring portion 16 is configured to receive an end portion of the container body 12, such that a sidewall end 64 is inserted into the ring portion 16. In such an embodiment, the extents 46 extend inwardly from the inner surfaces 24, 30 of the ring portion 16.

As mentioned above, the ring portion 16 may be formed through a molding process. In order to form the extents 46 in such a molding process, the rim 34 includes recessed portions 36 and apertures 38 to accommodate the mold tooling necessary to form the extents 46. Additionally, recessed portions 36 and apertures 38 can be used as a quality check to ensure that the extents 46 have fully engaged apertures 102 in the sidewall 70. When extents 46 have fully engaged the apertures 102, the flaps 86 become visible when looking through the recessed portions 36 and apertures 38.

As mentioned, the lid 14 can also include a cover portion 18. The cover portion 18 has an annular rim 54 and a center disk portion 60 that may be recessed. The cover portion can also include a skirt 56 extending downwardly from the rim 54 in a manner substantially perpendicular to the rim 54. Like the skirt 40 of the rim portion 16, the skirt 56 of the cover portion 18 need not be continuous around the entire rim 54 and may terminate at ends 58. The skirt ends 58 of the cover portion skirt 56 may correspond to the skirt ends 42 of the ring portion skirt 40, such that when the cover portion 18 is closed onto the ring portion 16, the skirt ends 42, 58 are positioned adjacent one another to form a substantially continuous skirt 40, 56 around the periphery of the lid 14.

The cover portion can also include a lift tab 58. The lift tab 62 provides a gripping element for use by a consumer to effect the opening of the cover portion 18.

In the manufacturing process, the container body 12 and lid 14 are formed independent from one another before being assembled together. During the assembly process, the lid ring portion 16 is first aligned with the container opening 68, as seen in FIG. 1. Again, in one embodiment, the cross-sectional shape of the bottom wall 78 is substantially similar to that of the lid 14. In such an embodiment, the lid 14 may be oriented or aligned with the similarly-shaped bottom wall 78. However, this need not be the case. While the bottom wall 78 dictates the general shape of the second end 66 of the sidewall 70, the lid 14 dictates the general shape of the first end 64 of the sidewall 70.

Once the ring portion 14 is aligned with the container opening 68, the upper and lower sections 22, 28 of the lid ring portion 14 are inserted into the container opening 68 proximate the first end 64 of the sidewall 70. The lower section 28 can extend radially inward towards the center of the ring portion 16 in order to help guide and facilitate the insertion of the ring portion 14 into the container opening 68.

The lid 14 may either be inserted into the container opening 68 by machine automation or manually by hand. The lower section's 28 radial inward taper and the extents' inclined bottom surface 50 aid in aligning and inserting the ring portion 16 into the container opening 68. The upper and lower sections 22, 28 of the ring portion 14 are inserted into the container opening 68 until the bottom surface 90 of the rim 34 is seated on the upper sidewall lip 76.

Once the upper and lower sections 22, 28 of the ring portion 14 are inserted into the container opening 68 as described above, the extent 46 comes into contact with the flap 86. In the embodiment shown in FIG. 4, the extent 46 displaces the flap 86 outward, thereby creating an aperture 102 in the sidewall 70. Once the extent 46 displaces the flaps 86 and engages the aperture 102, the lid 14 and container 12 become secured together. While it is the intent that lid 14 and container 12 will be permanently affixed to one another, in certain embodiments, the lid 14 and container 12 can be removably secured together.

From the foregoing, it may be seen that the container/lid assembly of the present invention is particularly well suited for the proposed usages thereof. Furthermore, since certain changes may be made in the above invention without departing from the scope hereof, it is intended that all matter contained in the above description or shown in the accompanying drawing be interpreted as illustrative and not in a limiting sense. It is also to be understood that the following claims are to cover certain generic and specific features described herein.

I claim:

1. A container/lid assembly comprising:
a container including a continuous sidewall having a first end and a second end;
at least one aperture extending through said container sidewall proximate said first end;
a lid having a ring portion; and
at least one projection extending from said lid ring portion configured to engage said aperture in said container sidewall for securing said lid to said container.

2. The assembly of claim 1, wherein said container first end is substantially open and said container second end is substantially closed.

3. The assembly of claim 1, wherein said aperture is formed by a series of cuts.

4. The assembly of claim 3, wherein said cuts form a flap in said container sidewall that is displaced when said aperture is engaged by said projection.

5. The assembly of claim 1, wherein said lid ring portion is configured to be received by said sidewall first end and said projection extends outwardly from an outer surface of said lid ring portion.

6. The assembly of claim 1, wherein said projection includes a top surface for interlocking said lid with said container and an inclined bottom surface for facilitating the insertion of said lid into said container first end.

7. The assembly of claim 6, wherein said projection allows said lid ring portion to be received by said container first end, but restricts said lid ring portion from being readily removed from said container first end after said projection engages said aperture.

8. The assembly of claim 1, wherein said lid is configured to be permanently secured to said container.

9. The assembly of claim 1, wherein said lid ring portion includes an upper section and a lower section, said lower section extending radially inward to facilitate the insertion of said lid into said container.

10. The assembly of claim 1, wherein said container sidewall includes more than one aperture and said lid ring portion includes more than one projection.

11. The assembly of claim 10, wherein said apertures are circumferentially spaced around said container sidewall and said projections are correspondingly spaced around said lid ring portion.

12. The assembly of claim 1, wherein said lid further comprises a cover portion hingedly attached to said ring portion.

13. The assembly of claim 12, wherein said ring portion and said cover portion are integrally molded as a single component.

14. A container/lid assembly comprising:
a container including a continuous sidewall, an open end and a closed end;
at least one cut extending through said sidewall proximate said open end, said cut forming an aperture;
a lid having a ring portion and cover portion, wherein said ring portion and cover portion are hingedly coupled and are integrally molded as a single component, and wherein said ring portion is configured to be received by said container open end; and
at least one extent extending outwardly from an outer surface of said ring portion, wherein said extent is configured to engage said aperture in said container sidewall for interlocking said lid to said container.

15. A lid for a container, said lid comprising:
a ring portion including at least one extent extending therefrom, wherein said ring portion is configured to be received by a container sidewall and said extent is configured to engage an aperture in said container sidewall; and
a cover portion hingedly coupled to said ring portion, wherein said ring portion and cover portion are integrally molded as a single component.

16. The lid of claim 15, wherein said extent includes a top surface for interlocking said lid with said container and an inclined bottom surface for facilitating the insertion of said lid into said container.

17. The lid of claim 16, wherein said extent allows said ring portion to be received by said container sidewall but restricts said ring portion from being readily removed from said container sidewall after said extent engages said aperture.

18. The lid of claim 15, wherein said ring portion includes an upper section and a lower section, said lower section extending radially inward to facilitate the insertion of said lid into said container.

19. A method of attaching a lid to a container comprising the steps of:
providing a container having a continuous sidewall with at least one aperture extending therethrough and an opening;
providing a lid having a ring portion with at least one projection extending therefrom configured to engage said aperture in said container sidewall for securing said lid to said container;
aligning said lid ring portion with said container opening;
inserting said lid ring portion into said container opening; and
causing said projection to engage said aperture such that said lid is secured to said container.

20. The method of claim 19, wherein said projection includes a top surface and a bottom surface that is inclined to aid the step of inserting said lid ring portion into said container opening.

21. The method of claim 20, wherein said projection allows said lid ring portion to be inserted into said container sidewall but restricts said lid ring portion from being readily removed from said container sidewall after the step of causing said projection to engage said aperture has occurred.

22. The method of claim 19, wherein said lid ring portion includes an upper section and a lower section, said lower section extending radially inward to aid the step of inserting said lid ring portion into said container opening.

23. The method of claim 19, wherein said container sidewall includes more than one said aperture, said apertures being circumferentially spaced around said container sidewall and said lid ring portion includes more than one projection, said projections being correspondingly spaced around said lid ring portion.

24. The method of claim 19, wherein said lid is configured to be permanently secured to said container.
